(19) United States
(12) Patent Application Publication
(10) Pub. No.: US 2014/0376771 A1
(43) Pub. Date: Dec. 25, 2014

(54) SYSTEM FOR COLLECTING GROWTH INFORMATION OF CROPS IN GREENHOUSE

(71) Applicant: Electronics and Telecommunications Research Institute, Daejeon (KR)

(72) Inventors: Ae Kyeung MOON, Daejeon (KR); Kyuhyung KIM, Daejeon (KR); Soo In LEE, Daejeon (KR)

(73) Assignee: Electronics and Telecommunications Research Institute, Daejeon (KR)

(21) Appl. No.: 14/194,950

(22) Filed: Mar. 3, 2014

(30) Foreign Application Priority Data
Jun. 19, 2013 (KR) 10-2013-0070418

(51) Int. Cl. G06K 9/00

(52) U.S. Cl. CPC G06K 9/00657
USPC 382/103

(57) ABSTRACT

A system provides a collecting growth information of crops in greenhouse. In view of the above, it is possible to estimate the growth and yields of crops depending on the size of the greenhouse and the number of the crops in the greenhouse by collecting growth information of the crops such as plant lengths, leaf areas, internode lengths, fruit color, and the number of fruits of the reference crops.

### RELATED APPLICATIONS

This application claims the benefit of Korean Patent Application No. 10-2013-0070418, filed on Jun. 19, 2013, the disclosure of which is incorporated herein in its entirety by reference.

### FIELD OF THE INVENTION

The present invention relates to a system for collecting growth information of crops in a greenhouse, and more specifically, to a system for estimating growth information of groups of crops based on the growth information on reference crops.

### BACKGROUND OF THE INVENTION

In recent years, systems for automatically controlling environment in a greenhouse have appeared due to the increase of the number of crops in the greenhouse. The environment in the greenhouse needs to control differently from moment to moment depending on a growth stage, a growing condition and the occurrence of disease and pest of crops. The growth information about the crop in the greenhouse may act as the most influential factor in determining the environmental control level of the greenhouse.

A method for controlling the environment in the greenhouse is made by the application of the similar principle as air conditioners. In connection with the method for controlling the environment of the greenhouse, Korean Laid-Open Patent Publication No. 2010-0032079, which is laid-open published on Mar. 25, 2010, discloses a method for controlling a cumulative thermometer so as to automatically control the environment of a greenhouse.

However, in the above patent publication, while the temperature of the greenhouse can be controlled, growth information of crops in the greenhouse is not being collected automatically, but being measured with the naked eye of the user. For that reason, although it is desired to expect the harvest in order for the import and export of the crops, collecting information about the crops for the import and export still relies on hard manual labor one by one.

### SUMMARY OF THE INVENTION

In view of the above, the present invention provides a system for collecting growth information of crops in a greenhouse that is capable of observing reference crops representing an sample of a group of crops, adjusting an estimated statistical value by varying the number of the reference crops, and acquiring a picture excluding the occulation of leaves and the occluation of crops using the reference crops, as well as that is capable of removing diffused reflection by driving a light emitting device depending on illuminance when acquiring the picture while increasing the accuracy of image recognition and correctly estimating the size and harvest time of the crops by using a multi-view camera. However, the technical subjects of the present invention are not limited to the foregoing technical subject, and there may be other technical subjects.

In accordance with any one of solutions to the aforementioned subject of the present invention, it is possible to estimate the growth and yields of crops depending on the size of the greenhouse and the number of the crops in the greenhouse by collecting growth information of the crops such as plant lengths, leaf areas, internode lengths, fruit color, and the number of fruits of the reference crops.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other objects and features of the present invention will become apparent from the following description of the embodiments given in conjunction with the accompanying drawings, in which:

FIG. 1 is a configuration diagram illustrating a system for collecting growth information of crops in a greenhouse in accordance with an embodiment of the present invention;

FIG. 2 depicts an embodiment wherein the growth information collecting system illustrated in FIG. 1 is installed in a greenhouse;

FIG. 3 is a block diagram of a growth information collecting apparatus for crops in a greenhouse shown in FIG. 1 in accordance with an embodiment of the present invention;

FIG. 4 is a block diagram of a growth information collecting apparatus for crops in a greenhouse shown in FIG. 1 in accordance with another embodiment of the present invention;

FIGS. 5A, 5B and 5C illustrate the comparison of the photographs for obtaining the growth information of a prior art and a present invention;

FIG. 6 is a flow chart of a method for collecting growth information of crops in a greenhouse in accordance with an embodiment of the present invention; and

FIG. 7 is a flow chart of a method for collecting growth information of crops in a greenhouse in accordance with another embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art. However, the present invention may be embodied in different forms, but it is not limited thereto. In the drawings, further, portions unrelated to the description of the present invention will be omitted for clarity of the description, and like reference numerals and like components refer to like elements throughout the detailed description.

In the entire specification, when a portion is “connected” to another portion, it means that the portions are not only “connected directly” with each other but they are electrically connected” with each other by way of another device therebetween. Further, when a portion “comprises” a component, it means that the portion does not exclude another component but further comprises other component unless otherwise described. Furthermore, it should be understood that one or more other features or numerals, steps, operations, components, parts or their combinations can be or are not excluded beforehand.

Hereinafter, the embodiments of the present invention will be described in detail with reference to the accompanying drawings.

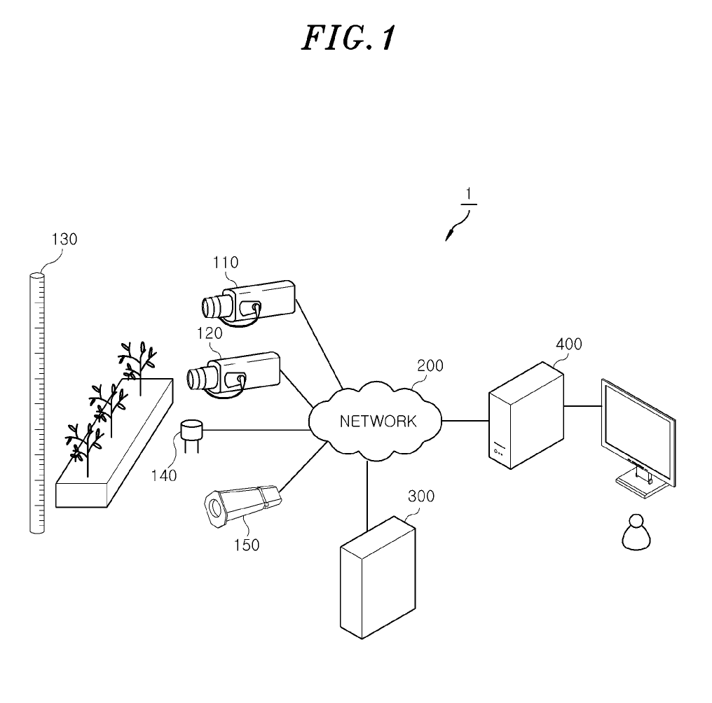

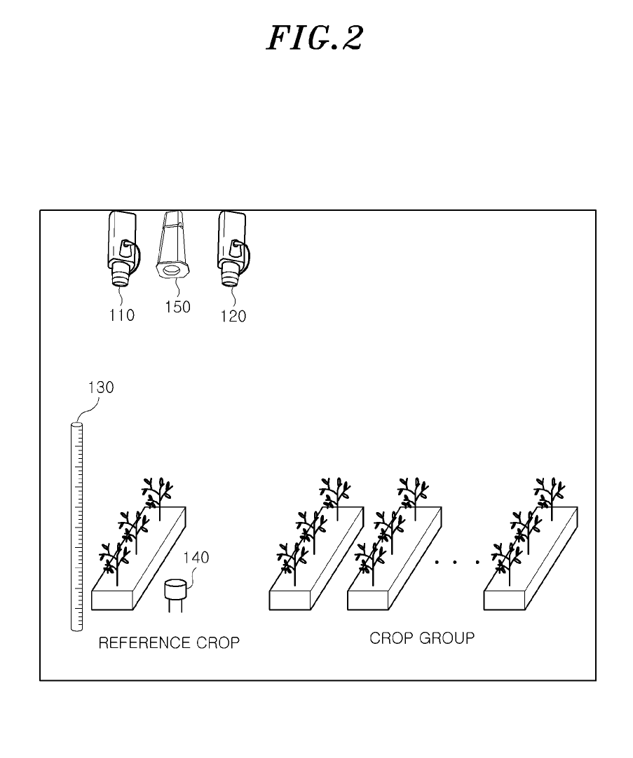

FIG. 1 is a configuration diagram illustrating a system for collecting growth information of crops in a greenhouse in accordance with an embodiment of the present invention; and FIG. 2 depicts an embodiment wherein the growth information collecting system shown in FIG. 1 is installed in a greenhouse. Referring to FIGS. 1 and 2, a growth information collecting system 1 for crops in a greenhouse may include a first camera 110, a second camera 120, a length measuring device 130, a photo sensor 140, at least one light emitting device 150, a growth information collecting apparatus 100 for crops in a greenhouse, and an output device 400. However, it should be noted that the growth information collecting system 1 shown in FIGS. 1 and 2 is only an example of the present invention and the present invention is not construed to be limited to those illustrated in FIGS. 1 and 2.

The respective components of FIGS. 1 and 2 may be typically connected through a network 200. For example, as shown in FIGS. 1 and 2, the first camera 110 and the second camera 120 may be connected to the growth information collecting apparatus 300 via the network 200. While both of the first camera 110 and second camera 120 are required in this embodiment of the present invention, either only one of the first and second cameras 110 and 120 may be required in another embodiment of the present invention. The optical sensor 140 may also be connected to the growth information collecting apparatus 300 via the network 200, and the light emitting device 150 may also be connected to the growth information collecting apparatus 300 via the network 200. Further, the growth information collecting apparatus 300 may be connected to the output device 400 via the network 200. Here, the growth information collecting apparatus 300 may incorporate therein the output device 400. For example, in case where a server and a terminal are integrated into one unit, an ability of the output device 400 may be implemented by any one of various abilities demonstrated by the growth information collecting apparatus 300. In addition, the length measuring device 130 may be removed if the first camera 110 or the second camera 120 equips with a distance sensor (not shown).

The network 200 used herein refers to a physical connection topology capable of exchanging information between the respective nodes such as terminals and servers, which may include, e.g., the Internet, LAN (Local Area Network), Wireless LAN (Local Area Network), WAN (Wide Area Network), PAN (Personal Area Network), 3G network, 4G network, LTE network, Wi-Fi network, or the like but is notlimited thereto. Further, it is understood that the first camera 110, the second camera 120, the length measuring device 130, the optical sensor 140, the light emitting device the light emitting device 150, the growth information collecting apparatus 300, and the output device 400 are also not limited to those illustrated in FIG. 1.

Each of the first camera 110 and the second camera 120 may be a camera to capture the crops in the greenhouse in order to obtain growth information of the crops. While both of the first camera 110 and the second camera 120 may be needed in this embodiment of the present invention, the first camera 110 or the second camera 120, that is, either only one of them may be needed in another embodiment of the present invention. This reason is that this embodiment of the present invention acquires distance information using the two cameras but another embodiment of the present invention acquires the distance information using one camera equipped with a distance sensor. In addition to the aforementioned two cases, any methods may be employed in the present invention if they are able to acquire the growth information of crops in a greenhouse through any combination of different variables. In this connection, the reason to acquire the distance information is that the color or size of an object in a picture captured by the camera(s) may be changed with the change in the distance between the camera(s) and the photographed object. Thus, if it is possible to acquire the distance information with only one camera, the one camera can be employed. However, if the cameras do not have an ability to acquire the distance information, a plurality of cameras may be needed to acquire the distance information. While the present invention has described the combinations of i) one camera with a distance sensor and/or ii) at least two cameras without any distance sensor, it is not intended to exclude any other combinations except the aforementioned combinations.

The length measuring device 130 may be used to measure a plant length that is indicative of a length of at least one reference drop. The length measuring device 130 may be an instrument capable of measuring the length of the reference crop. The length measuring device 130 may be necessary when a single camera (e.g., the first camera 110 or the second camera 120) does not equip with a distance sensor. On the contrary, when a pair of the first camera 110 and the second camera 120 is employed, the length measuring device 130 may be removed even if the cameras do not equip with the distance sensors. When a single camera (e.g., the first camera 110 or the second camera 120) does not equip with the distance sensor, information about the plant length of the reference crop can be acquired by the length measuring device 130.

The optical sensor 140 may be provided to measure an amount of light irradiated to the reference crop. The light emitting device 150 may be turned-on and turned-off on a basis of the amount of light measured by the optical sensor 140 and the illuminance of the light emitting device 150 may be adjusted depending on the amount of light measured by the optical sensor 140.

The growth information collecting apparatus 300 may collect the growth information of crops in a greenhouse based on the picture collected from the first camera 110 or the second camera 120. The growth information collecting apparatus 300 may also control the turn-on and turn-off and the illuminance of the light emitting device 150 based on the amount of light measured by the optical sensor 140. Further, the growth information collecting apparatus 300 may control the first camera 110 or the second camera 120 so that it can move in up, down, left, or right directions. Thus, the first camera 110 or the second camera 120 may include a moving member, e.g., a wheel, and the growth information collecting apparatus 300 may control the movement of the first camera 110 or the second camera 120 depending on the location of an object, that is, the location of the reference crop. Further, the growth information collecting apparatus 300 may perform color compensation with respect to the collected pictures and extract at least one piece of growth information such as a plant length, a leaf area, an internode length, fruit color, and the number of fruits of the reference crop viewed in the collected pictures. In addition, the growth information collecting apparatus 300 may estimate the growth and yields of a group of crops based on the extracted growth information.

Such a growth information collecting apparatus 300 may be embodied by a computing device which can be connected with remote servers or terminals through the network 200. Herein, the computing device may include, for example, a notebook computer, desktop computer, laptop computer, or others in which a web browser is installed. Further, the growth information collecting apparatus 300 may be implemented in various terminals capable of accessing remote servers or terminals through the network 200. The growth information collecting apparatus 300 may be a wireless communication device that ensures portability and mobility, for example, which may include any kind of handheld-based wireless communication devices such as a handset for PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet), smartphone, smart pad, Tablet PC, or the like.

The reference crop may be a sample that is representative of the group of crops. By way of example, a sample of watermelons that are one of the crop group may be required in order to estimate the harvest and shipping date of the watermelons. For example, assuming that one hundred seedlings of a watermelon are a crop group and ten seedlings of the watermelon are reference crops, it is possible to estimate the harvest and shipping date of one hundred watermelons through the use of the growth rate, the number of fruits, or fruit color of ten watermelons. Thus, the reference crops may be the sample collection of the crop group, and the growth information collecting system 1 in accordance with the present invention may estimate the growth information of the crop cluster by observing the reference crop and collecting the growth information of the reference crop.

Referring to FIG. 2, there is shown an embodiment of implementing the growth information collecting system 1 for crops in a greenhouse. The embodiment of FIG. 2 shows that the first camera 110 and the second camera 120 are located on the upper side of the greenhouse but is not limited thereto. The first camera 110 and the second camera 120 may be located at any place if they are placed on the opposite side of the reference crop. Further, while the light emitting device 150 is shown to be located on the upper side of the greenhouse, it may be located at any place if it is placed to irradiate the reference crop.

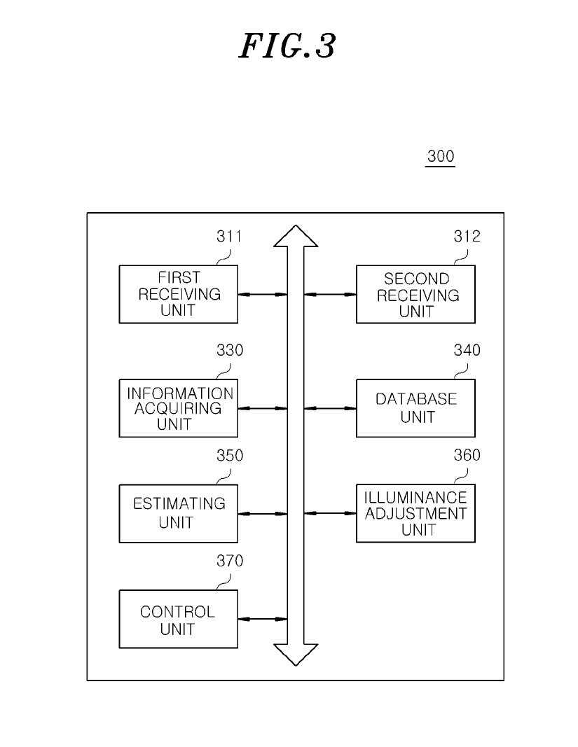

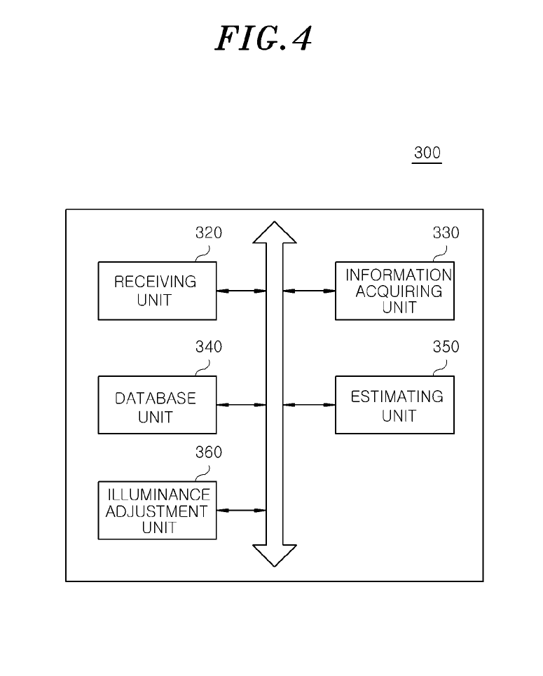

FIG. 3 is a block diagram of the growth information collecting apparatus for crops in a greenhouse shown in FIG. 1 in accordance with an embodiment of the present invention; and FIG. 4 is a block diagram of the growth information collecting apparatus for crops in a greenhouse shown in FIG. 1 in accordance with another embodiment of the present invention.

Hereinafter, FIG. 3 will describe an example where all of the first camera 110 and the second camera 120 are employed and FIG. 4 will describe an example where either one of the first camera 110 and the second camera 120 is employed. As described above, the former example requires two cameras in consideration of the change in color saturation and size of an object depending on a distance to the object and the latter example requires one camera because the camera is provided with a distance sensor.

Referring to FIG. 3, the growth information collecting apparatus 300 of the embodiment of the present invention may include a first receiving unit 311, a second receiving unit 312, an information acquiring unit 330, a database unit 340, an estimating unit 350, an illuminance adjustment unit 360, and a control unit 370.

When the growth information collecting apparatus 300 or a server (not shown) in cooperation with the growth information collecting apparatus 300 transmits a growth information program or webpage of crops in a greenhouse to the output device 400, the output device 400 installs or opens the program or the webpage of a relevant service. Further, a growth information collecting program for crops in a greenhouse may be run on the growth information collecting apparatus 300 using a script running in web browser. The web browser refers to an application enabling to use a WWW (World Wide Web) service which locates and displays a hypertext described in HTML (Hyper Text Mark-up Language) and includes, for example, Netscape, Explorer, Chrome and others.

The connection to the network 200 means that the first camera 110, the second camera 120, the light emitting device 150, the growth information collecting apparatus 300, and the output device 400 are communicatively connected one another, and what the connection to the network 200 is generated means that the growth information collecting apparatus 300 produces a communication entity at a communication contact with a terminal which is connected to the network 200 in order for the communication. Thus, the growth information collecting apparatus 300 may exchange data with the terminal through the communication entity.

The first receiving unit 311 receives a first picture that captures the reference crop in the greenhouse from the first camera 110. When capturing the picture, the first camera 110 may capture the reference crop along with the length measuring device 130. Therefore, the first receiving unit 311 may collect the pictures of the reference crop containing a view of the length measuring device 130 therein. The first picture, thus, may be a picture of the reference crop in which the view of the length measuring device 130 is included. Further, the reference crop may be a sample collection of the crop group. Accordingly, the larger the number of the sample groups is, the more the statistical accuracy is increased. If accuracy is required, therefore, it is possible to increase the number of reference crops, and if required an approximate estimation only, it is possible to reduce the number of reference crops. These may be adjusted in accordance with their uses.

The second receiving unit 312 receives a second picture in which the reference crop is captured by the first camera 110 and the second camera 120. In this embodiment, the first camera 110 and the second camera 120 may be a stereo camera or multi-view camera. A 2D or 3D picture may be captured through the use of the first camera 110 and the second camera 120. The second picture may be a picture of the reference crop that is received from the first camera 110 and the second camera 120.

Further, the growth information collecting system 1 may include the light emitting device 150 to irradiate light to the reference crop until the first camera 110 or the second camera 120 operates. The light emitting device 150 may be mounted at a place on the opposite side of the reference crop. Further, the growth information collecting system 1 may include the optical sensor 140 used for measuring an amount of light irradiated to the reference crop. The growth information collecting apparatus 300 may further include the illumination adjustment unit 360 which is capable of adjusting the illuminance of the light emitting device 150 based on the amount of light that is measured by the optical sensor 140. In this case, the optical sensor 140 may be disposed at a place where the reference crop is located, and the illumination adjustment unit 360 may be connected with the optical sensor 140 through wires or wirelessly over the network 200.

The information acquiring unit 330 acquires at least one piece of growth information of the reference crop from the first and second pictures. In this case, the growth information may be at least one of a plant length indicative of a length of the reference crop, a leaf area, a fruit color, an internode length, and the number of fruits of the reference drop. Thus, the information acquiring unit 330 may acquire the growth information of the reference crop from the first and second pictures by the use of image processing techniques including color compensation, object recognition and others. When acquiring the growth information, the information acquiring unit 330 may acquire the information in consideration that the color and size of the object may vary depending on a distance from a camera. As an example, it is assumed that the reference crop is planted at about 1 meter intervals from the first camera 110 and the second camera 120. The size of an object that is captured at a place that is spaced about 1 meter apart from the camera may be different from that of the object that is captured at a place that is spaced about 2 meters apart from the camera. Accordingly, the information acquiring unit 330 may identify the size of the object depending on the distance through the first and second pictures and acquire at least one piece of the growth information of the object.

The database unit 340 serves to store the acquired growth information. The estimation unit 350 may estimate the growth information of the crop group based on the stored growth information. Further, the estimation unit 350 may estimate the growth information such as a growth degree, growth stage or yield of the crop group based on the stored growth information. As an example, it is assumed that the number of the reference crop is one and the number of the crops in a crop group is one hundred. Then, when it is measured that the number of fruits grown in the one reference crop is ten and the average size of the fruits is 10 cm, it may be estimated that the number of fruits to be harvested from the crop group is 1000 and the average size thereof is 10 cm. Consequently, it is possible to estimate growth information of the crop group based on data obtained by observing the reference crop in accordance with an embodiment of the present invention.

The control unit 370 may control the movement of the first camera 110 and the second camera 120. The control unit 370 may communicate with the first camera 110 and the second camera 120 by wires or wirelessly. Thus the first camera 110 and the second camera 120 may be moved in up, down, left, and right directions under the control of the control unit 370. Here, the first camera 110 or the second camera 120 may be a single camera, stereo camera, multi-view camera, or the like.

The following is a description about a method for collecting growth information of crops in a greenhouse in accordance with an embodiment of the present invention.

In recent, as the number of crops in the greenhouse increases, a system for automatically controlling environment in the greenhouse has appeared. The environment in the greenhouse needs to control differently from moment to moment depending on a growth stage, growing condition, and the occurrence of disease and pest of the crops. The growth information may act as the most influential factor in determining the environmental control level of the greenhouse.

However, growth information of crops is not collected automatically but measured with the naked eye of the users. For that reason, although it is required to expect the yield of the crops in order for the import and export of the crops, collecting growth information of the crops for the import and export relies a hard manual labor, which makes it difficult to expect yields of the crops.

Therefore, the present invention is capable of observing reference crops representing an sample of a group of crops, adjusting an estimated statistical value by varying the number of the reference crops, and acquiring a picture excluding the occulation of leaves and the occluation of crops using the reference crops, as well as that is capable of removing diffused reflection by driving a light emitting device depending on illuminance when acquiring the picture while increasing the accuracy of image recognition and correctly estimating the size and harvest time of the crops by using a multi-view camera.

Referring to FIG. 4, the growth information collecting apparatus 300 may include a receiving unit 320, an information acquiring unit 330, a database unit 340, an estimating unit 350, and an illuminance adjustment unit 360. As set forth above, the embodiment of FIG. 4 employs either one of two cameras unlike that of FIG. 3. The camera employed in this embodiment is assumed as the first camera 110 of FIG. 3 and the following description will be made as such.

The receiving unit 310 receives a picture in which at least one reference crop in a greenhouse is captured by the camera 110. The camera 110 may be a single camera and may include a distance sensor which measures the distance to the reference crop. Thus, the camera 110 may measure the distance between the camera 110 and an object to be captured and provide an absolute value of the size of the object. Further, the camera 110 may be any one of a single camera, a stereo camera and a multi-view camera and may capture a 2D or 3D picture.

The information acquiring unit 330 acquires at least one piece of growth information of the reference crop from the picture. In this case, the growth information may be at least one of a plant length indicative of the length of the reference crop, a leaf area, a fruit color, an internode length, and the number of fruits of the reference crop. In addition, the reference crop may be a sample collection of a crop group.

Further, the growth information collecting system 1 may include at least one light emitting device 150. The light emitting device 150 may irradiate light to the reference crop when the camera 110 operates. Further, the growth information collecting system 1 may include an optical sensor 140 used for measuring an amount of light irradiated to the reference crop. In this connection, the growth information collecting apparatus 300 may further include an illumination adjustment unit 360 used for adjusting the illumination of the light emitting device 150 based on the amount of light measured by the optical sensor 140. In this embodiment, the light emitting device 150 may be installed at a location on the opposite side of the reference crop, and the optical sensor 140 may be disposed at a location where the reference crop is placed and may be connected with the illumination adjustment unit 360 by wires or wirelessly.

The database unit 340 serves to store the acquired growth information of the reference crop. The database unit 340 may map metadata of a location and identification of the reference crop, and a type, planted time, harvest time of the crop group with the growth information to build a database.

The estimation unit 350 estimates growth information of the crop group based on the stored growth information of the reference crop. Specifically, the estimation unit 350 may estimate at least one piece of growth information of the crop group such as a growth degree, growth stage, or yield based on the stored growth information.

Further details of the method for collecting the growth information of crops in a greenhouse illustrated in FIGS. 3 and 4 will not be described below since they are identical to the description made through FIGS. 1 to 3 and can be easily inferred from the description.

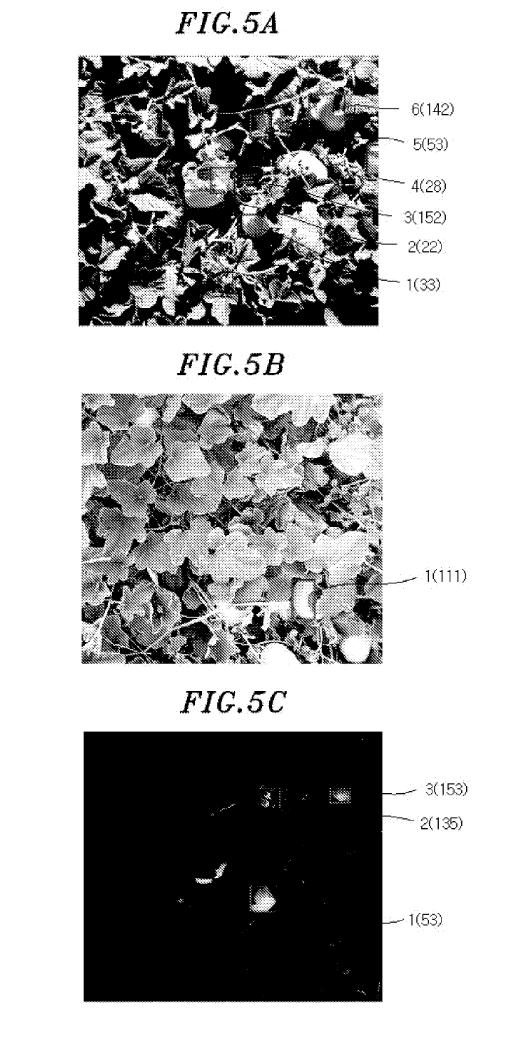

FIGS. 5A, 5B and 5C illustrate the comparison of the photographs for obtaining the growth information of a prior art and a present invention. Here, numbers in FIGS. 5A, 5B and 5C indicated a number of the melon, numbers of brackets in FIGS. 5A, 5B and 5C indicated a degree of color saturation. Specifically, in FIG. 5A of the prior art, it is possible to recognize the number of melons, but it is not possible to know exactly what the color the melons have because of severe diffused reflection caused by the characteristic of the melons in yellow. That is, it is difficult to identify the degree of ripening from the melons suffered from the diffused reflection. Accordingly, an administrator needs to visit the greenhouse directly to check the color of the melons. FIG. 5B of the prior art is a picture captured in the natural light. Nevertheless, diffused reflection also occurs due to the characteristic of yellow color even in natural light. Therefore, it is not possible to know exactly the color. FIG. 5C is a picture that is captured by driving the light emitting device in accordance with an embodiment of the present invention. It can be seen that color saturation of melons is accurately represented despite of diffused reflection characteristic.

In accordance with an embodiment of the present invention, it is possible to collect growth information of crops such as a plant length, a leaf area, a fruit color, an internode length, the number of fruits, or ripening degree through the use of image processing techniques such as a color compensation or the like, to estimate the yield of the crop group based on the yield of the reference crop, and to identify growth degree of the crop group based on the growth stage of the reference crop. In case of crops that belong in the crop group, they may demonstrate the growth rate faster than the reference crop owing to the competitiveness of the crops and may have differences in nutrient feeding and optical absorption. In accordance with the embodiment of the present invention, it is possible to calculate an accurate statistics from the sample in consideration of even these differences.

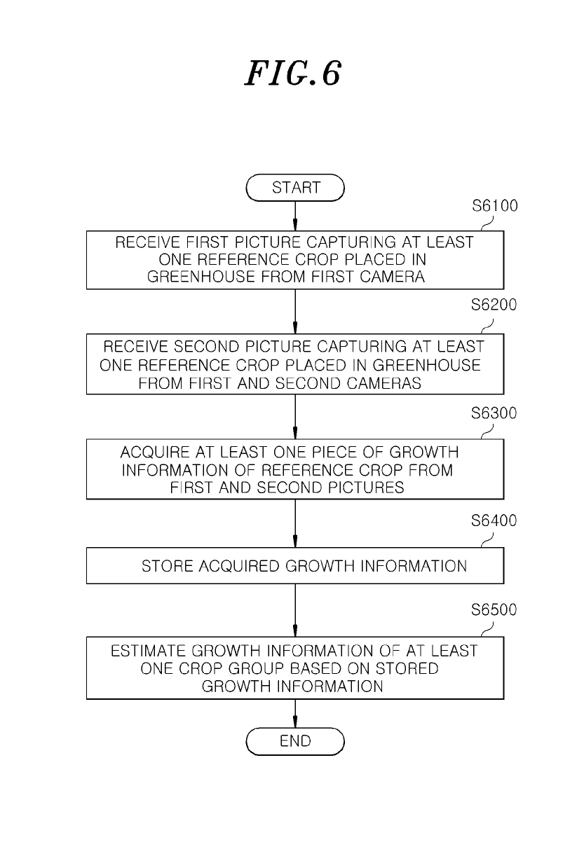

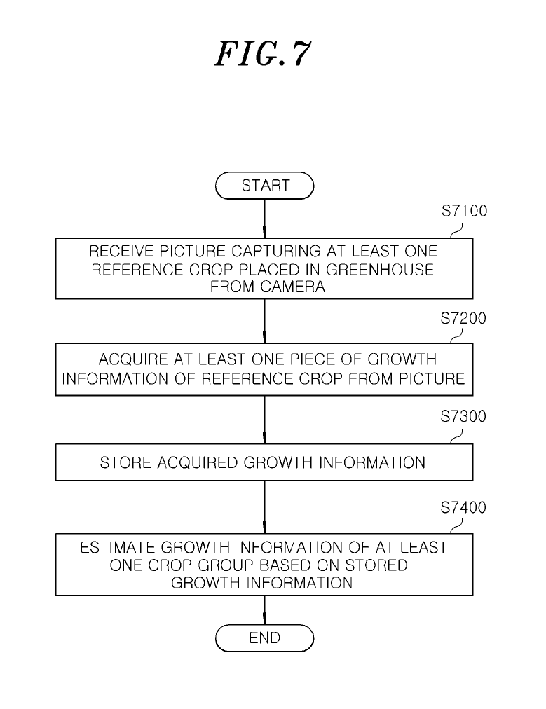

FIG. 6 is a flow chart of a method for collecting growth information of crops in a greenhouse in accordance with an embodiment of the present invention; and FIG. 7 is a flow chart of a method for collecting growth information of crops in a greenhouse in accordance with another embodiment of the present invention.

Referring to FIG. 6, the growth information collecting system receives a first picture that shoots at least one reference crop planted in a greenhouse from the first camera (S6100). Next, the growth information collecting system receives the second picture that shoots the reference crop from the first camera and the second camera (S6200).

Thereafter, the growth information collecting system acquires at least one piece of growth information of the reference crop from the first and second pictures (S6300) and stores the acquired growth information (S6400).

Subsequently, the growth information collecting system estimates growth information of at least one crop group based on the stored growth information (S6500).

The order of the above operations described in blocks S6100 to S6500 is only an example and is not limited thereto. Thus, the order of the operations described in blocks S6100 to S6500 may be mutually exchanged, and some of these operations may be simultaneously executed or removed.

Referring to FIG. 7, the growth information collecting system receives a picture that shoots at least one reference crop planted in a greenhouse from the camera (S7100). Thereafter, the growth information collecting system acquires at least one piece of growth information of the reference crop from the picture (S7200) and stores the acquired growth information (S7300).

Subsequently, the growth information collecting system estimates growth information of at least one crop group based on the stored growth information (S7400).

The order of the above operations described in blocks S7100 to S7400 is only an example and is not limited thereto. Thus, the order of the operations described in blocks S7100 to S7400 may be mutually exchanged, and some of these operations may be simultaneously executed or removed.

Further details of the method for collecting growth information of crops in a greenhouse illustrated in FIGS. 6 and 7 will not be described below since they are identical to the description made through FIGS. 1 to 5 and can be easily inferred from the description.

The method for collecting growth information of crops in a greenhouse described in FIGS. 6 and 7 may be implemented in the form of recording media including instructions executable by a computer, such as applications or program modules that are executed by a computer. The computer readable media may be any available media that can be accessed by a computer and may include volatile and nonvolatile media, and removable and non-removable media. Further, the computer readable media may include any computer storage media and communication media. The computer storage media may include any volatile and nonvolatile media and removable and non-removable storage media that are implemented in any methods or technologies for the storage of information such as data and computer-readable instructions, data structures, program modules, or other data. The communication media may include a transport mechanism or any information delivery media for transmitting computer readable instructions, data structures, program modules or other data of modulated data signal such as carrier waves.

The method for collecting growth information of crops in a greenhouse may be run by an application basically installed in a terminal (which may include programs included in the platform or operating system that is primarily installed in the terminal) and an application (i.e., a program) that a user directly installs in the terminal through an application store server or application providing server such as a web server related to the application or the relevant service. In terms of the above, the method for collecting growth information of crops in a greenhouse may be implemented in the form of an application that is basically installed in a terminal or is directly installed by a user and stored in a non-transitory storage medium that is readable by a computer such as a terminal.

Description of the present invention as described above are intended for illustrative purposes, and it will be understood to those having ordinary skill in the art that this invention can be easily modified into other specific forms without changing the technical idea and the essential characteristics of the present invention. Accordingly, it should be understood that the embodiments described above are exemplary in all respects and not limited thereto. For example, respective components described to be one body may be implemented separately from one another, and likewise components described separately from one another may be implemented in an integrated type.

The scope of the present invention is represented by the claims described below rather than the foregoing detailed description, and it should be construed that all modifications or changes derived from the meaning and scope of the claims and their equivalent concepts are intended to be fallen within the scope of the present invention.

What is claimed is:

1. A system for collecting growth information of crops in a greenhouse, the system comprising:
a first receiving unit configured to receive a first picture that shoots at least one reference crop placed in the greenhouse from a first camera;
a second receiving unit configured to receive a second picture that shoots the reference crop from the first camera and a second camera;
an information acquiring unit configured to acquire at least one piece of growth information of the reference crop from the first and second pictures;
a database unit that stores the acquired growth information; and
an estimating unit configured to estimate growth information of at least one crop group based on the stored growth information.

2. The system of claim 1, wherein the growth information comprises one of a plant length indicative of the length of the reference crop, a leaf area, a fruit color, an internode length, and the number of fruits of the reference crop.

3. The system of claim 1, wherein the reference crop is a sample collection of the crop group.

4. The system of claim 1, further comprising:
at least one light emitting device configured to irradiate light to the reference crop when the first camera or the second camera is operated,
wherein the light emitting device is installed on the opposite side of the reference crop.

5. The system of claim 4, further comprising:
an optical sensor configured to measure an amount of light irradiated to the reference crop; and
an illuminance adjustment unit configured to adjust the illuminance of the light emitting device based on the amount of light measured by the optical sensor,
wherein the optical sensor is installed at a location where the reference drop is placed and is connected with the illuminance adjustment by wires or wirelessly.

6. The system of claim 1, wherein each the first camera or the second camera comprises one of a single camera, a stereo camera and a multi-view camera; and
the first camera or the second camera shoots a 2D or 3D picture.

7. The system of claim 1, further comprising:
a length measuring device for measuring a length of the reference crop; and
wherein the first camera captures the reference crop including the length measuring device.

8. The system of claim 1, further comprising:
a control unit configured to control the movement of the first camera and the second camera;
the first camera and the second camera communicate with the control unit by wires or wirelessly.

9. The system of claim 1, wherein the estimating unit is configured to estimate at least one piece of growth information among a growth degree, growth stage and yield of the crop group based on the stored growth information.

10. A system for collecting growth information of crops in a greenhouse, the system comprising:
a receiving unit configured to receive a picture that captures at least one reference crop placed in the greenhouse from a camera;
an information acquiring unit configured to acquire at least one piece of growth information of the reference crop from the picture;
a database unit that stores the acquired growth information; and
an estimating unit configured to estimate growth information of at least one crop group based on the stored growth information.

11. The system of claim 10, wherein the growth information comprises one of a plant length indicative of the length of the reference crop, a leaf area, fruit color, an internode length, the number of fruits of the reference crop; and
the reference crop is a sample collection of the crop group.

12. The system of claim 10, wherein the camera comprises a distance sensor for measuring a distance to the reference crop.

13. The system of claim 10, further comprising:
at least one light emitting device configured to irradiate light to the reference crop when the camera is operated;
an optical sensor configured to measure an amount of light irradiated to the reference crop; and
an illuminance adjustment unit configured to adjust the illuminance of the light emitting device based on the amount of light measured by the optical sensor,
wherein the light emitting device is installed at a location on the opposite side of the reference crop, and
the optical sensor is disposed at a site where the reference crop is placed and is connected with the illuminance adjustment unit by wires or wirelessly.

14. The system of claim 10, wherein the camera comprises one of a single camera, a stereo camera and a multi-view camera; and
the camera shoots a 2D or 3D picture.

15. The system of claim 10, wherein the estimating unit is configured to estimate at least one piece of growth information among a growth degree, a growth stage, a yield of the crop group based on the stored growth information.
